(19) United States
(12) Patent Application Publication
(10) Pub. No.: US 2026/0126948 A1
(43) Pub. Date: May 7, 2026

(54) Method and System for Mid-Track Cuepoint Detection and Use

(71) Applicant: Spotify AB, Stockholm (SE)

(72) Inventors: Daniel Stoller, Berlin (DE); Nicola Montecchio, Berlin (DE)

(21) Appl. No.: 19/191,176

(22) Filed: Apr. 28, 2025

Related U.S. Application Data
(60) Provisional application No. 63/717,539, filed on Nov. 7, 2024.

(51) Int. Cl. G06F 3/16; G06F 16/683

(52) U.S. Cl. CPC G06F 3/165; G06F 16/683

(57) ABSTRACT

An example computer-implemented method includes selecting an audio segment from a middle section of an audio track and the computing system obtaining a frequency-component representation of a time window that spans (i) the selected audio segment and (ii) context audio before and/or after the selected audio segment. Further, the example method includes providing, to a trained machine-learning model, the frequency-component representation, the trained machine-learning model having been trained by training data that identifies cuepoints within frequency-component representations of audio segments within beginning and end sections of a plurality of training audio tracks, each cuepoint being a fade-in cuepoint or a fade-out cuepoint. Still further, the example method includes obtaining, from the trained machine-learning model, based on the provided frequency-component representation, a prediction that a mid-track cuepoint is present in the selected audio segment, and the computing system generating metadata for the audio track based on the prediction.

### REFERENCE TO RELATED APPLICATION

This application claims priority to U.S. Provisional Ser. No. 63/717,539 , filed Nov. 7, 2024, the entirety of which is hereby incorporated by reference.

### TECHNICAL FIELD

The present disclosure relates to the field of digital audio content and, more specifically, to machine-based detection and use of audio cuepoints.

### BACKGROUND

Cuepoints in audio are markers that define particular moments in the audio, such as the start or end of a verse, a chorus, or another segment for instance. These markers may serve many useful purposes. For instance, the markers may serve as reference points to allow disc-jockeys (DJs) or other users to instantly jump to temporal locations in an audio track. Further, the markers may serve as transition points, allowing seamless transition between streaming and/or playout of audio tracks, such as by beginning a transition at a designated end cuepoint (or fade-out cuepoint) near the end of one track and finishing the transition at a designated start cuepoint (or fade-in cuepoint) near the beginning of a next track.

### SUMMARY

Machine-based processing can be used to predict where start and end cuepoints are located within audio tracks, in order to facilitate fading playout from one track to another. In particular, a trained machine-learning model (e.g., neural network) could work well to predict the locations of start and end cuepoints in a given audio track if the training data used to train the model includes labeled start and end cuepoints in each of many tracks.

A machine-learning model that is trained based on audio tracks labeled as to start and end cuepoints, however, may not work well to predict the occurrence of intervening cuepoints within the audio track, such as points of transition between verses, choruses, etc., of the audio track for instance. One reason for this technical issue is that such training data would teach the model about start and end cuepoints that are within the starting and ending portions of audio tracks, and those starting and ending portions may be characteristically different than intervening portions of the audio tracks. For instance, the starting or ending portions of a song may differ from the main content of a song in terms of musical theme, presence or absence of vocal content, and repetition of musical structure, among other possibilities.

One potential approach to facilitate predicting mid-track cuepoints is to train a machine-learning model based on labeled mid-track cuepoints in particular, perhaps many labeled mid-track cuepoints per track for potentially thousands of audio tracks. Unfortunately, however, given the ever-increasing extent of content available for streaming and other playout, it may be impractical to label all of those mid-track cuepoints. Further, training the model based on so many cuepoint labels may be computationally expensive and/or may require additional data storage and present other technical difficulties.

The present disclosure provides a technical mechanism to help overcome this issue, facilitating machine-based prediction of mid-track cuepoints using a machine-learning model that is trained based on labeled start and/or end cuepoints, potentially without a need for any advanced labeling of mid-track cuepoints.

In particular, the disclosure provides for training a machine-learning model based on small audio segments from randomly selected time positions throughout training audio tracks, along with associated context audio per audio segment and an indication per audio segment of whether and if so where the audio segment includes a start or end cuepoint. Even though this training data is thus based on start and end cuepoints in particular, the small size, context audio, and random time positions of the training audio segments throughout training audio tracks provides technical advantages by usefully teaching the machine-learning model more broadly what constitutes a cuepoint, thus enabling the machine-learning model to predict not just start and end cuepoints but also mid-track cuepoints.

Accordingly, in one respect, disclosed is an example computer-implemented method. The method includes selecting, from an audio track, an audio segment, the audio track containing a beginning section, a middle section, and an end section, and the selected audio segment being in the middle section. Further, the method includes obtaining a frequency-component representation of a time window that spans (i) the selected audio segment and (ii) context audio before and after the selected audio segment. Still further, the method includes providing the frequency-component representation to a trained machine-learning model that has been trained by training data that identifies start and end cuepoints within frequency-component representations of audio segments within beginning and end sections of a plurality of training audio tracks. Yet further, the method includes obtaining, from the trained machine-learning model, based on the provided frequency-component representation, a prediction that at least one mid-track cuepoint is present in the selected audio segment. The method then includes generating metadata for the audio track based on the prediction.

In another respect, disclosed is another example computer-implemented method. This method includes a computing system obtaining training data sets corresponding with respective training windows within audio tracks, with each data set including a frequency-component representation of a respective time window that spans (i) a randomly selected audio segment of an audio track and (ii) context audio before and after the randomly selected audio segment, and with each data set further including an indication of whether and if so where the randomly selected audio segment of the audio track contains a cuepoint that is either a start cuepoint or an end cuepoint. Further, the method includes the computing system applying a machine-learning trainer to the training data sets, to produce a machine-learning model that is configured to take as input a frequency-component representation of a test time window that spans (i) a test audio segment from a middle section of a test audio track and (ii) context audio before and after the test audio segment, and to provide as output a prediction of whether the test audio segment contains a mid-track cuepoint.

In yet another respect, disclosed is a computing system including at least one processor, non-transitory data storage, and program instructions stored in the non-transitory data storage and executable by the at least one processor to cause the computing system to carry out operations such as those in the example methods for instance.

Still further, in another respect, disclosed is non-transitory data storage (e.g., one or more instances of computer-readable storage) having stored program instructions executable by at least one processor of a computing system to cause the computing system to carry out operations such as those in the example methods for instance.

Yet further, in still another respect, disclosed is a computer program comprising program instructions executable by at least one processor of a computing system to carry out operations such as those in the example methods for instance.

In addition, in another respect, disclosed is a system including various means for carrying out operations such as those in the example methods for instance.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 is a simplified block diagram of a media content delivery system, in accordance with example embodiments.

FIG. 2 is a simplified block diagram of an electronic device, in accordance with example embodiments.

FIG. 3 is a simplified block diagram of a media content server, in accordance with example embodiments.

FIG. 4 is a simplified illustration of an example audio track.

FIG. 5 is an illustration of crossfade between audio tracks using start and end cuepoints.

FIG. 6 is a simplified illustration of example training time windows in an audio track.

FIG. 7 is a simplified block diagram of an example computing system, in accordance with example embodiments.

FIG. 8 is a flow chart, in accordance with example embodiments.

FIG. 9 is another flow chart, in accordance with example embodiments.

### DETAILED DESCRIPTION

Example methods, devices, and systems are described herein. It should be understood that the word “example” or “exemplary” to the extent used herein means “serving as a possible instance or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, any separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Still further, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

In addition, unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### Example System and Device Architecture

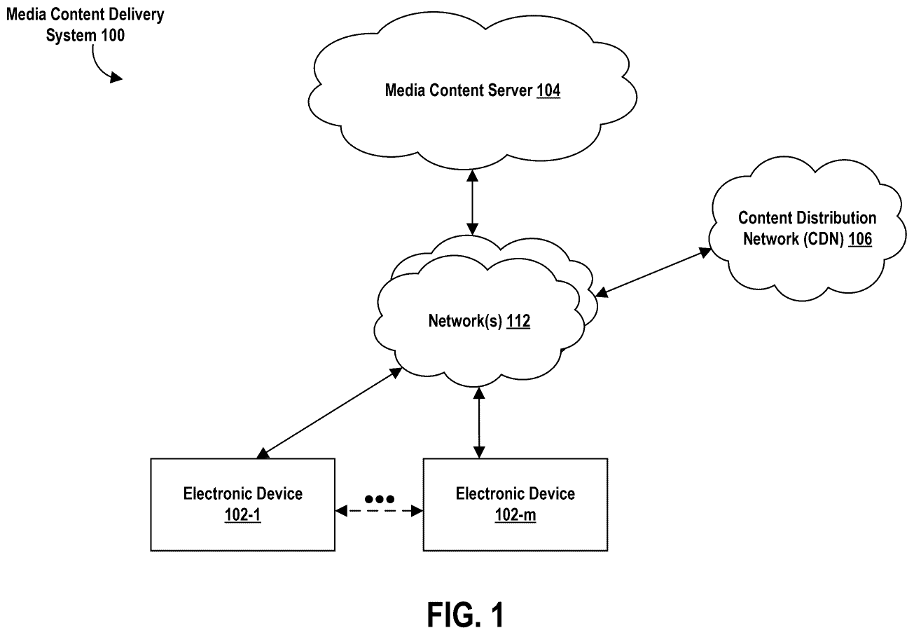

FIG. 1 is a simplified block diagram illustrating an example media content delivery system 100. The example media content delivery system 100 includes one or more electronic devices 102 (e.g., electronic device 102-1 to electronic device 102-m, where m is an integer greater than one), at least one media content server 104, and at least one content distribution network (CDN) 106. With this arrangement, the media content server 104 may be configured to stream or otherwise provide media content items, possibly through the CDN 106, for receipt and playout by the electronic devices 102.

Media content items (also referred to as “media content”, “content”, “media items”, and “content items”) may take various forms. For instance, the media content items may include audio (e.g., music, spoken word, podcasts, audiobooks, etc.), video (e.g., short-form videos, music videos, television shows, movies, clips, previews, etc.), text (e.g., articles, blog posts, emails, etc.), image data (e.g., image files, photographs, drawings, renderings, etc.), games (e.g., 2D or 3D graphics-based computer games, etc.), web pages, and/or any combination of these and/or other types of content. In some embodiments, media content items may include one or more audio media content items, such as particular songs, podcasts, or audiobooks, that may be referred to as “audio items,” “tracks,” and/or “audio tracks”.

As shown, one or more networks 112 may communicatively couple the components of the media content delivery system 100. The one or more networks 112 may include public communication networks, private communication networks, or a combination of both public and private communication networks. For example, the one or more networks 112 could include one or more wide area networks (WANs) such as the Internet, a cellular network, and a satellite communication network, and/or could include one or more local area networks (LAN), virtual private networks (VPN), metropolitan area networks (MAN), peer-to-peer networks, mesh networks, and/or ad-hoc connections, among other possibilities.

Example electronic devices 102, which may be associated respectively with one or more users, may take various forms. For instance, an electronic device 102 could be a personal computer, a mobile electronic device, a wearable computing device, a laptop computer, a tablet computer, a mobile phone, a feature phone, a smartphone, an infotainment system, a digital media player, a gaming device, a speaker, a television (TV), and/or any other electronic device capable of playing and/or presenting media content (e.g., controlling playback of media items, such as music tracks, podcasts, videos, etc.) Alternatively, the electronic device 102 may be a component of another system such as a home entertainment system, a radio/alarm clock, or an infotainment system of a vehicle, for instance, and may enable that system to play media content.

In some embodiments, the electronic devices 102 may be the same type of device as each other (e.g., electronic device 102-1 and electronic device 102-m are both speakers). In other embodiments, the electronic devices 102 may include two or more different types of devices.

The example electronic devices 102 may also be configured to communicate with each other through direct or networked communication links, represented by the dashed arrow in FIG. 1, which may include wireless and/or wired connections. For instance, the electronic devices 102 may communicate with each other through a direct wired connection such as a High Definition Multimedia Interface (HDMI) connection, or through a direct wireless communication such as short or medium range wireless signaling using technologies such as BLUETOOTH, BLUETOOTH LOW ENERGY (BLE), ZIGBEE, WI-FI, WIRELESSHART, Near Field Communication (NFC), Radio Frequency Identification (RFID), infrared, Thread, Z-Wave, MiWi, Low-Rate Wireless Personal Area Network (LR-WPAN), or Internet Protocol v. 6(IPv6 ) over WPAN (6oWPAN), among other possibilities. Alternatively or additionally, the electronic devices 102 may communicate with each other through one or more networks (perhaps one or more of network(s) 112), such as through a wireless mesh network, a LAN, a cellular network, or other form of network. Through these inter-device connections, one electronic device 102-1 may stream or otherwise transmit media content to another electronic device 102-m to facilitate playout of the media content.

An example electronic device 102 may be configured to play media content items, outputting the associated media content for presentation to a user and/or outputting the associated media content through an inter-device connection to another electronic device for presentation to a user.

The electronic device 102 may obtain these media content items from local data storage and/or through transmission from the media content server 104, CDN 106, or other device or system. For instance, the electronic device 102 may include or otherwise have access to local data storage containing some of these media content items and may be configured to retrieve the media content items from that local data storage and to play out the retrieved media content items. Further the electronic device 102 may be configured to interwork with the media content server 104 to cause the media content server 104 to stream, progressively download, and/or otherwise transmit media content items to the electronic device 102, and the electronic device 102 may be configured to receive and play out those transmitted media content items as well. In some cases, an example electronic device 102 may also be configured to transmit to the media content server 104 indications of media content items, possibly the media content items themselves, for various purposes.

To facilitate playout of media content items, the example electronic device 102 may be programmed with a media application. The media application may provide a user interface (e.g., a graphical user interface (GUI)) through which a user of the electronic device 102 can control playing of media content items, and the media application may include a media-playback engine configured to obtain and play out media content items in response to user control commands and/or other triggers.

For instance, the media application may receive a user's control commands related to playout of media content items, such as requests to play particular media content items or playlists of media content items and commands to pause or stop media playout, to adjust volume, or to jump to a next track or a previous track, among other possibilities. And the media application may be configured to respond to those commands by engaging in associated control signaling with the media content server 104 to control streaming or other transmission of media content items from the media content server 104 to the electronic device 102 and/or by engaging in associated control of playing out media content items from local data storage.

An example media content server 104 may be configured to receive media commands or other requests from electronic devices 102 and to respond accordingly. To facilitate this, in some embodiments, the media content server 104 may provide an application programming interface (API), such as a voice API or a connect API, accessible by one or more of the electronic devices 102. The media content server 104 may also be configured to validate (e.g., authenticate) electronic devices 102 using a key service, such as by exchanging one or more keys (e.g., tokens) with the electronic device 102.

The example media content server 104 may include or otherwise have access to data storage storing media content items available for transmission to electronic devices 102, as well as playlists each defining a sequence or other set of media content items for playout. Playlists may be defined by users of the electronic devices 102, by editors associated with media-providing services, and/or by machine-based processes, among other possibilities. The media content server 104 may also be configured to provide electronic devices 102 with information about the available media content items and playlists, such as web pages or other interfaces presenting the information, to enable users of the electronic devices 102 to obtain this information and to correspondingly control media playout.

Further, in some implementations, the media content server 104 may interwork with the one or more CDNs 106 to facilitate management and transmission of media content items and associated information to the electronic devices 102. For instance, a CDN 106 may cache media content items, playlists, and associated data and may be configured to transmit this data to electronic devices 102 through the network(s) 112 in response to requests from the electronic devices.

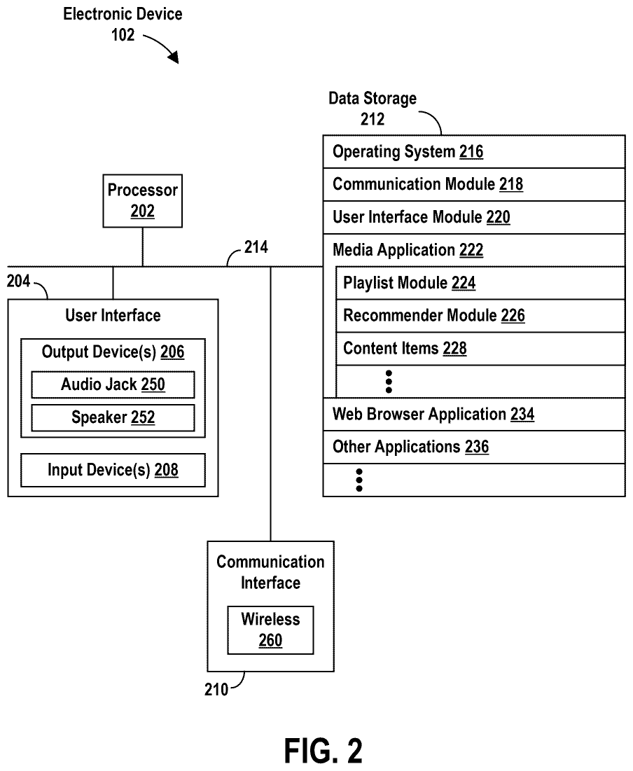

FIG. 2 is a simplified block diagram illustrating an example electronic device 102. As shown in FIG. 2, the example electronic device 102 includes a processor 202, a user interface 204, a communication interface 210, and non-transitory data storage 212, any or all of which may be integrated together to various extents and/or communicatively linked with each other by a system bus, network, or other connection mechanism 214, on a chipset or other integrated circuit, among other possibilities.

The processor 202 may include one or more general purpose processors (e.g., microprocessors) and/or one or more specialized processors (e.g., digital signal processors (DSPs), graphics processing units (GPUs), neural processing units (NPUs), etc.)

The user interface 204 may include one or more output devices 206 and one or more input devices 208 to facilitate interaction with a user. Example output devices 206 may include audio output devices such as an audio jack 250, a sound speaker 252, and/or another port or the like for connecting with speakers, earbuds, headphones, and/or other listening devices, and video output devices, such as a display panel for instance. Further, example input devices 208 may include an audio input device such as a microphone and other types of user input mechanisms such as a touch-sensitive panel, a keyboard or keypad, and/or a mouse or trackpad, among other possibilities. In some embodiments, the user interface may support voice input, and the electronic device 102 may include or interact with a voice recognition system to facilitate processing of voice input from a user.

The communication interface 210 may include one or more components to facilitate communicating with other electronic devices 102, with the media content server 104, with the CDN 106, with associated media presentation systems, and/or with other devices and/or systems. For instance, the communication interface 210 may include one or more wireless communication interfaces 260 configured to facilitate direct or networked communication according to any of various wireless communication protocols, such as those noted above, among others. In addition or alternatively, the communication interface 210 may include one or more wired communication interfaces supporting direct or networked communication according to any of various wired communication protocols, such as HDMI, Universal Serial Bus (USB), THUNDERBOLT, and/or Ethernet, among others.

The non-transitory data storage 212 may include one or more volatile and/or non-volatile storage components (e.g., flash, optical, magnetic, read only memory (ROM), random access memory (RAM) (e.g., dynamic RAM (DRAM), static RAM (SRAM), or double data rate RAM (DDRAM)), electronically programmable read only memory (EPROM), and/or electronically erasable programmable read only memory (EEPROM), etc.), which may be integrated in whole or in part with the processor 202 or may be provided separately. As further shown, the data storage 212 may store program instructions, which may be executable by the processor 202 to carry out various electronic device operations.

These instructions may define programs, modules, and/or data structures, such as but not limited to an operating system 216, a communication module 218, a user interface module 220, a media application 222, a web browser application 234, and one/or more other applications 236. Further, these instructions may be structured as separate software programs, procedures, modules, or the like, and/or may be combined together and/or otherwise arranged in various embodiments.

The operating system 216 may define procedures for handling various basic system services and for performing hardware-dependent tasks. The communication module 218 may define procedures supporting connection and communication with other computing devices and systems (e.g., with the media content server 104, the CDN 106, with various media presentation systems, and/or with other electronic devices 102) through the communication interface 210 and possibly the one or more networks 112. And the user interface module 220 may define procedures supporting use of the user interface 204, such as to receive commands and/or other input from a user and to provide media playback and other output to the user.

In line with the discussion above, the media application 222 may be a program application configured to access a media-providing service of a media-content provider associated with the media content server 104 for instance, and may be configured to support requesting, receiving, processing, and presenting of media content items. In some implementations, the media application 222 may include a media-player, a streaming-media application, and/or any other appropriate application or component to facilitate retrieval and/or receipt of media content and playing of the media content. Further, the media application 222 may define various logic modules, such as a playlist module 224, a recommender module 226, and/or a content-items module 228.

The playlist module 224 may store sets of media items for playback in a predefined order. Further, the playlist module 224 may be configured to generate playlists. In some embodiments, the playlist module 224 may include a diffusion-model component, a large-language-model component, and/or a nearest-neighbor-search component, among other possibilities. The recommender module 226 may be configured to identify and/or display recommended media content items (e.g., for inclusion in a playlist). The recommender module 226 may likewise include a diffusion-model component, a large-language-model component, and/or a nearest-neighbor-search component, among other possibilities. The content-items module 228 may be configured to store media content items, including audio items such as songs, podcasts, and audiobooks, for playback, and to provide requests for media content items to the media content server 104. In some implementations, the content-items module 228 may include or otherwise have access to a set of vector representations for the media content items.

The web browser application 234 may be configured to support user access, viewing, and interaction with web sites. To facilitate this, the web browser application 234 may be configured to use standard web-based communication protocols, web-based applications, and/or web-based content formats and/or may be configured to use proprietary protocols, applications, and formats.

The other applications 236 in the non-transitory data storage 212 of the electronic device 102 may then include any of a variety of additional applications, supporting operations such as word processing, calendaring, mapping, weather, time keeping, virtual digital assistant, presenting, drawing, instant messaging, e-mail, telephony, video conferencing, photo management, video management, music playing, video playing, 2D gaming, 3D (e.g., virtual reality) gaming, electronic book reading, and/or workout management, among other possibilities.

The example electronic device 102 may also include one or more sensors (not shown) such as accelerometers, gyroscopes, compasses, magnetometer, light sensors, near field communication transceivers, barometers, humidity sensors, temperature sensors, proximity sensors, range finders, and/or other devices for sensing and measuring various operational, environmental and/or other conditions, among possibly other components.

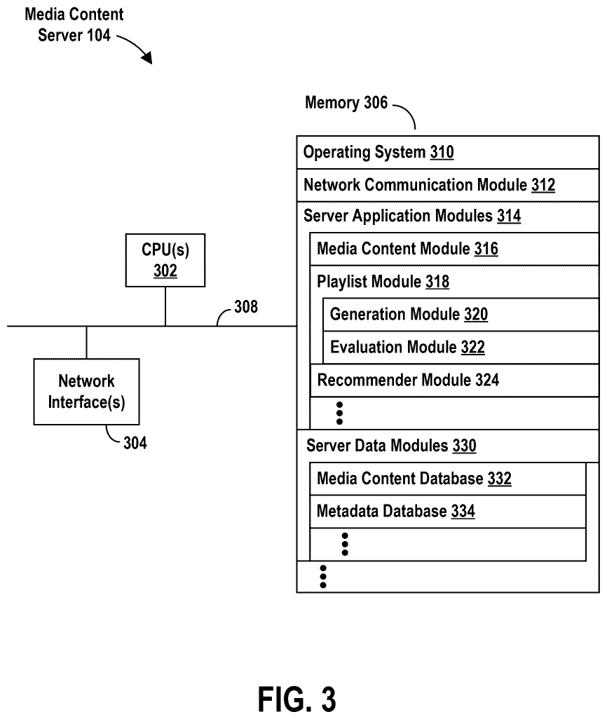

FIG. 3 is next a simplified block diagram of an example media content server 104. As shown in FIG. 3, the example media content server 104 includes a processor 302, a communication interface 304, and non-transitory data storage 306, any or all of which may be integrated together to various extents and/or communicatively linked with each other by a system bus, network, or other connection mechanism 308, on a chipset or other integrated circuit, among other possibilities.

The processor 302 may include one or more general purpose processors (e.g., microprocessors) and/or one or more specialized processors (e.g., DSPs, GPUs, NPUs, etc.)

The communication interface 304 may comprise a network communication interface to facilitate communicating with the electronic devices 102 and the CDN 106 through the one or more networks 112. For instance, the communication interface 304 may include a wired and/or wireless Ethernet communication module, among other possibilities.

The non-transitory data storage 306 may include one or more volatile and/or non-volatile storage components (e.g., flash, optical, magnetic, ROM, RAM) (e.g., DRAM, SRAM, or DDRAM), EPROM, and/or EEPROM, etc.), which may be integrated in whole or in part with the processor 302 or may be provided separately. As further shown, the data storage 306 may store program instructions, which may be executable by the processor 302 to carry out various media-content-server operations.

These instructions may define programs, modules, and/or data structures, such as but not limited to an operating system 310, a network communication module 312, one or more server application modules 314, and one or more server data modules 330. Further, these instructions may be structured as separate software programs, procedures, modules, or the like, and/or may be combined together and/or otherwise arranged in various embodiments.

The operating system 310 may define procedures for handling various basic system services and for performing hardware-dependent tasks. And the communication module 312 may define procedures supporting connection and communication with other computing devices and systems, such as with the electronic devices 102 and the CDN 106, through the communication interface 304 and possibly through the one or more networks 112.

The one or more server application modules 314 may define procedures supporting providing and managing a content service. These server application modules 314 may include a media content module 316, a playlist module 318, and/or a recommender module 324, among other possibilities.

The media content module 316 may store and/or otherwise have access to media content items and may be configured to send (e.g., stream and/or progressively transmit) the media content items to the electronic devices 102. The playlist module 318 may store and/or otherwise have access to data defining sequences or other sets of media content items and may be configured to send those playlists to the electronic devices 102. The playlist module 318 may include a generation module 320 for generating playlists and media sets, and an evaluation module 322 for evaluating the playlists and media sets, e.g., before and after publication. Further, the playlist module 318 may include a diffusion-model component, a large-language-model component, and/or a nearest-neighbor-search component, among other possibilities.

The recommender module 324 may determine and/or provide media-content-item recommendations (e.g., for a playlist). In some embodiments, the recommender module 324 also includes a diffusion-model component, a large-language-model component, and/or a nearest neighbor-search component, among other possibilities.

The one or more server data modules 330 may manage the storage of and/or access to media items and/or metadata relating to media content items. As such, the one or more server data modules 330 may include a media content database 332 for storing media items and/or vector representations (e.g., vector embeddings) of the media content items, and a metadata database 334 for storing metadata relating to the media content items, such as genre, artist, and other information associated with the respective media content items.

The media content server 104 may also include a web server such as a Hypertext Transfer Protocol (HTTP) servers, File Transfer Protocol (FTP) servers, and may maintain or otherwise have access to web pages and other content defined with Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

The description of the media content server 104 as a “server” is intended as a functional description of the devices, systems, processor cores, and/or other components that provide the functionality attributed to the media content server 104. It will be understood that the media content server 104 may be a single server computer, or may comprise multiple server computers. Moreover, the media content server 104 may be coupled with CDN 106 and/or other servers and/or server systems, or other devices, such as other client devices, databases, content delivery networks (e.g., peer-to-peer networks), network caches, and the like. Further, in some embodiments, the media content server 104 may be implemented by multiple computing devices working together to perform the actions of a server system, such as to provide cloud-based server or cloud-computing service.

### Digital Audio Content and Streaming

Digital audio content may encompass a broad range of audio data that has been converted into a digital format, enabling it to be stored, processed, transmitted, and received by electronic devices. By way of example, digital audio content could include songs and other music, as well as spoken word recordings such as news broadcasts, podcasts, audiobooks, that offer listeners a convenient way to consume information and entertainment through auditory means. Further, digital audio content could combine spoken word with music or other sounds, creating rich, multi-layered audio experiences suitable for radio shows, multimedia presentations, and enhanced podcasts. And still further, digital audio content could constitute the audio portion of multimedia video content (e.g., of H.264/MPEG-4 or 3GP encoded content), such as the soundtrack of a movie, television show, online video, or live stream, among many other possibilities.

Digital audio content represents analog audio content as a sequence of digital information such as bits representing sequential frames of the analog audio. Digital audio content may be compressed or otherwise encoded using various encoding techniques (e.g., MP3, AAC, or Opus) to help reduce file size while maintaining quality and to help facilitate distribution of the audio through various techniques such as streaming, progressive downloading, bulk file transfer, or broadcasting, for instance.

Digital audio streaming involves transmitting a digital audio stream from a content source (e.g. media content server 104 or CDN 106) to an electronic device 102, typically over a network 112, for real-time playout of the audio by the electronic device 102 as the electronic device 102 receives the transmission. A variation of audio streaming is progressive downloading, where an electronic device 102 downloads a digital audio file in pieces and plays out the audio file before the entire download is finished. One technical difference between streaming and progressive downloading is that, with streaming, the electronic device 102 usually does not maintain a copy of the audio as the electronic device 102 plays it out, whereas with progressive downloading, the electronic device 102 ends up with a downloaded copy of the audio for possible later playout as well.

To prepare digital audio for streaming or other distribution, a computing system such as the media content server 104 may start with a digital audio file that defines a time sequence of digital audio data such as a sequence of audio frames, the computing system may encode the digital audio data of the file using an encoding algorithm to establish a corresponding time sequence of encoded digital audio data, and the computing system may segment the encoded digital audio data into smaller pieces or audio segments, which the computing system may store for transmission. Further, the computing system may generate multiple different encoded versions of the digital audio segments per file, using multiple different levels or types of encoding and compression, to facilitate adaptive switching between versions during transmission.

To facilitate streaming of an audio content item to an electronic device 102, the media content server 104 may employ a streaming protocol such as HTTP Live Streaming (HLS), Dynamic Adaptive Streaming over HTTP (DASH), or Real-Time Messaging Protocol (RTMP) to transmit the audio segments. These protocols manage the data transmission and adapt to varying network conditions. Additionally, the media content server 104 may handle user sessions, managing requests for specific audio streams and providing secure access through authentication and authorization mechanisms. The media content server 104 may also make use of the CDN 106, which may cache the audio content pieces on geographically distributed servers, to help reduce streaming latency and improve reliability and user experience.

On the receiving end, the media application 222 of the electronic device 102 may initiate a connection to the media content server 104 and request streaming of a specific audio content item. As the media application 222 receives the initial audio segments of the requested audio content in response to this request, the media application 222 may then start buffering and pre-loading a portion of the audio in the memory of the electronic device 102 to facilitate smooth playback even in the case of minor network interruptions. Further, the media application 222 may decode the audio pieces in order to uncover the original digital audio data and may convert that digital audio data to a form suitable for output. For instance, the media application 222 may play the decoded audio through an audio output device 206 of the electronic device 102 or through another electronic device 102. Further, the media application 222 may manage playback (e.g., play, pause, skip, and volume adjustment) through associated user-interface controls.

Adaptive streaming protocols such as those discussed above may allow the electronic device 102 to monitor network conditions and request different quality levels of digital audio content based on current bandwidth availability, thus providing consistent playback without interruptions in most cases. Further, the electronic device 102 may handle network errors and interruptions by attempting to reconnect to the media content server 104, by re-buffering when necessary, and by dynamically adjusting the stream quality to maintain a continuous audio experience.

### Detection and Use of Mid-track Cuepoints

As noted above, the present disclosure provides a technical mechanism to predict mid-track cuepoints using a machine-learning model (e.g., a neural network) that is trained based on labeled start cuepoints and/or end cuepoints, potentially without a need for any advanced labeling of mid-track cuepoints.

In particular, the disclosure provides for training such a model based on start cuepoints and/or end cuepoints, and the disclosure also provides for making use of the resulting, trained model as a basis to predict the presence of one or more mid-track cuepoints. Further, the disclosure provides for taking action based on the predicted presence of the one more mid-track cuepoints. For instance, the disclosure provides for establishing metadata that denotes the time location of one or more predicted mid-track cuepoints in an audio track, and providing the metadata with the audio track as a basis to enable a DJ or other end-user to quickly jump to a predicted mid-track cuepoint during playout of the audio track, and/or using the metadata for various purposes, such as to identify, mark, and/or extract audio-track sections (e.g., verse and chorus sections of music, etc.) extending from one predicted mid-track cuepoint to another, perhaps to provide a preview portion of the audio track, among other possibilities.

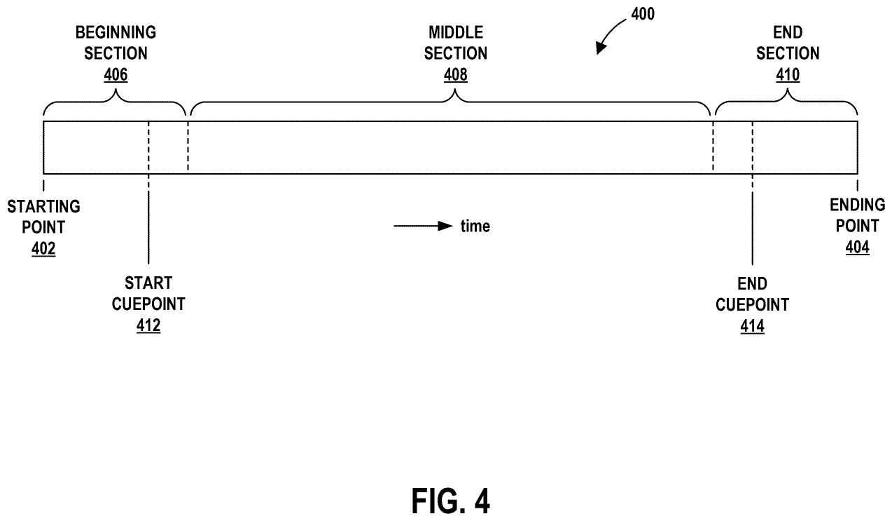

FIG. 4 is a simplified illustration of an example audio track 400, which may be a song, an audio book, a podcast, or another audio content item. The example audio track 400 defines a sequence of audio that extends in time from a starting point 402 to an ending point 404. Thus, if the media application 222 of an electronic device 102 would play this audio track 400 in full, the media application 222 would play the sequence of audio from time point 402 to time point 404.

As shown, the example audio track 400 includes a beginning section 406, a middle section 408, and an end section 410. The beginning section 406 may define an intro such as an opening part of the audio track that sets the tone and otherwise introduces main content of the track, possibly including a fade-in such as a gradual increase in volume from silence to a full volume level or possibly defining a cold open that abruptly starts at full volume, and possibly including a musical phrase or the like that leads into the main content of the track. The end section 410 may define an outro such as a concluding part of the track that brings it to a close, possibly including a fade-out as a gradual decrease in volume until the track ends in silence or possibly defining a hard stop or cold ending that ends abruptly without fading out, and possibly including a coda that brings the piece to an end. The middle section 408 may then define the main content of the audio track between the beginning and end sections; for instance, if the audio track is a song, the middle section 408 may be the portion of the song that contains verses and choruses of the song.

As further shown, the example audio track 400 includes a start cuepoint 412 within the beginning section 406 of the track and an end cuepoint 414 within the end section 410 of the track. In some examples, the start cuepoint 412 may demarcate where the beginning section 406 ends and the middle section 408 starts, and the end cuepoint 414 may demarcate where the middle section 408 ends and the ending section 410 starts.

These start and end cuepoints 412, 414 define locations in the track where it may work well to transition between transmission and/or playout of the audio track 400 and transmission and/or playout of another audio track, such as when the tracks are being provided and/or played sequentially as part of a playlist. By way of example, these start and end cuepoints 412, 414 may respectively define fade-in and fade-out time points in the audio track 400 for use to facilitate crossfade transitions.

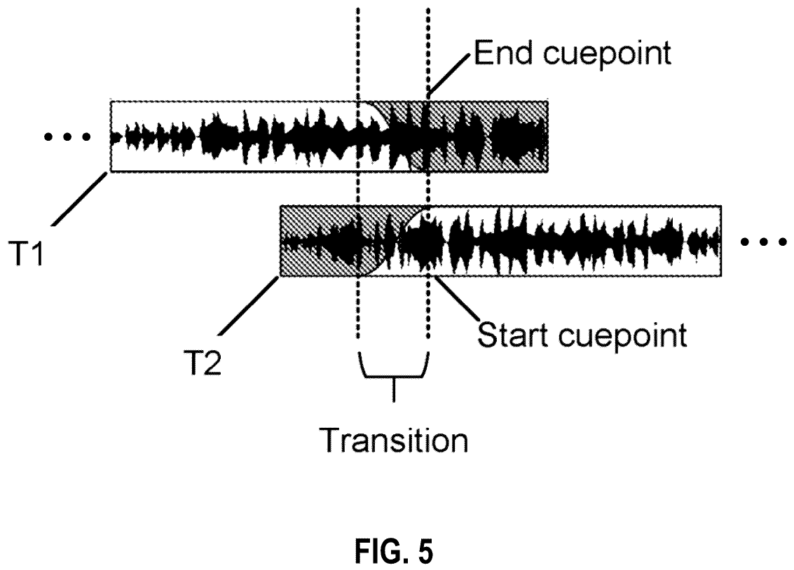

FIG. 5 illustrates how an example crossfade transition between two sequential audio tracks T1, T2 may make use of example start and end cuepoints. As shown in FIG. 5, a crossfade transition in playout of these tracks may involve overlapping playout of the two tracks while fading out the volume of track T1 and fading in the volume of track T2. In particular, an end cuepoint in track T1 may define a time point where the fading out of the volume of track T1 would be complete and track T1 would no longer be heard, and a start cuepoint in track T2 may define a time point where the fading in of track T2 would be complete and track T2 would be heard at its full volume. Implementing this crossfade transition may thus involve timing playout of the tracks such that the end cuepoint of track T1 aligns with the start cuepoint of track T2 as shown.

To facilitate smooth transition between audio tracks, it may be important to accurately determine the temporal locations of start and end cuepoints respectively in each track.

One way to determine the temporal locations of start and end cuepoints in each audio track is to have human users listen to each track and designate where it would make sense to have the start and end cuepoints, such as where intro or outro transitions occur in the track, and to have a computing system generate associated metadata per track, specifying in-track timestamps of these labeled start and end cuepoints. In other cases, more automated labeling techniques could be used.

Further, especially given the continued increase in the number of available audio tracks, another way to determine the temporal locations of start and end cuepoints in each audio track is to apply machine learning, namely, to apply a machine-learning model that is trained based on training data including labeled start and end cuepoints. For instance, a computing system could train a machine-learning model based on training data that includes potentially thousands of audio tracks having labeled start and end cuepoints, and the machine-learning model could learn from acoustic features (e.g., tempo, rhythm, beats, downbeats, tatums, patterns, sections, or other structures) at or near the temporal locations of the human-labeled start and end cuepoints, to learn typical acoustic features associated with start and end cuepoints. A computing system could then apply the trained machine-learning model to predict where start and end cuepoint are in a new audio track under test, based on consideration of the acoustic features of the new audio track.

As noted above, however, it would also be useful to determine mid-track cuepoints, such as points that demarcate where transitions occur between verses, choruses, and/or other user-recognizable audio within the middle section 408 of an audio track. As noted above, determining mid-track cuepoints may facilitate generating and providing metadata that allows a user to jump to temporal locations of a mid-track cuepoint during playout. Further, determining mid-track cuepoints may facilitate identifying, marking, and/or extracting audio-track sections, such as to provide a preview segment that extends from one mid-track cuepoint to another, among other possibilities.

As indicated above, having humans label mid-track cuepoints in many audio tracks may be impractical or impossible. Further, using machine-learning based on labeled start and end cuepoints may not work well to predict the presence of mid-track cuepoints, given likely characteristic differences between acoustic features of the beginning and ending sections 406, 410 and acoustic features of the middle section 408. In particular, as noted above, training a machine-learning model based on start and end cuepoints in the beginning and end sections of audio tracks may teach the machine-learning model how to predict with high confidence the presence of start and end cuepoints but may not teach the machine-learning model to predict with high confidence the presence of mid-track cuepoints.

As indicated above, the present disclosure provides mechanisms that may help to overcome these issues, facilitating use of labeled start and end cuepoints as a basis train a machine-learning model to predict the presence of mid-track cuepoints, and to facilitate use of the resulting trained machine-learning model to predict presence of mid-track cuepoints and associated use of those predicted mid-track cuepoints.

A computing system could train a machine-learning model to be able to predict mid-track cuepoints, by using training data representing audio segments that are randomly (i.e., randomly or pseudo-randomly) selected from throughout numerous training audio tracks, along with context audio per audio segment and optionally with an indication per audio segment of whether or not the audio segment includes a cuepoint, such as a start cuepoint, an end cuepoint, or another type of cuepoint.

The random distribution of these audio segments and their context audio from throughout the training audio tracks may help to train the machine-learning model to predict cuepoints at locations throughout an audio track under test, not limited to predicting start and end cuepoints.

Further, having the randomly selected audio segments and their context audio be small enough (perhaps on the order of 20 seconds and/or shorter than 10% of a typical audio track duration, among other possibilities), the machine-learning model may learn to predict the occurrence of cuepoints throughout an audio track, including mid-track cuepoints, rather than being limited to predicting the occurrence of start and end cuepoints. Namely, even though the human-labeled cuepoints may be merely the start and end cuepoints respectively within the beginning and end sections 406, 410 of training audio tracks, the model can learn to predict not only start and end cuepoints but also mid-track cuepoints. A reason for this is that, with small enough time segments of training audio, there may be more characteristic similarity between audio segments in the beginning and end sections 406, 410 of an audio track and audio segments in the middle section 408 of the audio track.

The model may thereby predict mid-track cuepoints based on evaluation of start cuepoints and/or end cuepoints. Further, consideration of start cuepoint information and/or end cuepoint information may enable the model to predict mid-track cuepoints having starting or ending musical characteristics. For instance, considering start cuepoints may enable the model to predict mid-track cuepoints that are at the beginning of a musical movement, such as high-intensity mid-track moments, whereas considering end cuepoints may enable the model to predict mid-track cuepoints that are at the end of musical movements.

Accordingly, a computing system could establish this training data based on potentially thousands of training audio tracks that have been labeled with start and end cuepoints. For instance, the computing system may access a data store that contains these training audio tracks as respective digital audio files, and the computing system may retrieve and analyze the training audio tracks to produce the training audio data.

As to each training audio track, the computing system could randomly select many training audio segments from throughout the audio track, with some of the selected audio segments being at least partly in the beginning and end sections 406, 410 of the audio track and other of the audio segments being at least partly in the middle section 408 of the audio track, and with some of the selected audio segments containing a labeled start or end cuepoint and others not containing a labeled start or end cuepoint. Further, for each selected audio segment, the computing system may identify context audio surrounding the selected audio segment in the training audio track. For instance, the computing system may identify preceding context audio that immediately precedes the selected audio segment and succeeding context audio that immediately follows the selected audio segment. Alternatively, the computing system may identify preceding and succeeding context audio that is spaced slightly from the selected audio segment, so there could be a small time gap (perhaps on the order of 0.05 to 0.3 seconds, among other possibilities) between the context audio and the selected audio segment.

The computing system may make each selected audio segment and its preceding and succeeding context audio relatively small. For instance, the computing system may make each selected audio segment just 20 seconds or perhaps another duration that is on the order of less than 10% of the overall duration of a typical audio track. Further, the computing system may make the preceding context audio of each selected audio segment be similarly small, and the computing system may make the succeeding context audio of each selected audio segment also be similarly small. Thus, the selected audio segment, the preceding context audio, and the succeeding context audio may each be 20 seconds long, among other possibilities.

To the extent any randomly selected audio segment happens to be too close to the start or end of the training audio track to be able to have the desired duration of context audio before or after the track, the computing system may silence-pad the context audio to provide a sufficient duration of context audio. For instance, if a randomly selected audio segment starts at 15 seconds after the start of a training audio track and if the desire is for the preceding context audio to be 20 seconds long, the computing system could deem the preceding context audio to be the first 15 seconds of the audio track prepended with 5 seconds of silence audio.

For each selected audio segment from a training audio track, the computing system may then read from the training audio track a training time window of audio that spans (i) the selected audio segment (as a main audio segment of the training time window) and (ii) the context audio before the selected audio segment and/or the context audio after the selected audio segment. In an example implementation where the selected audio segment, the preceding context audio, and the succeeding context audio are each 20 seconds in duration, and where both preceding and succeeding context audio are included without a gap, this training time window may thus be 60 seconds in duration.

In an example implementation, the computing system could restrict or filter its random selection of audio segments to include just audio segments whose preceding and succeeding context audio would not contain a known cuepoint, so as to provide non-cuepoint context for each audio segment. For instance, if the preceding or succeeding context audio of a randomly selected audio segment happens to include a labeled start or end cuepoint, then the computing system could discard that random selection.

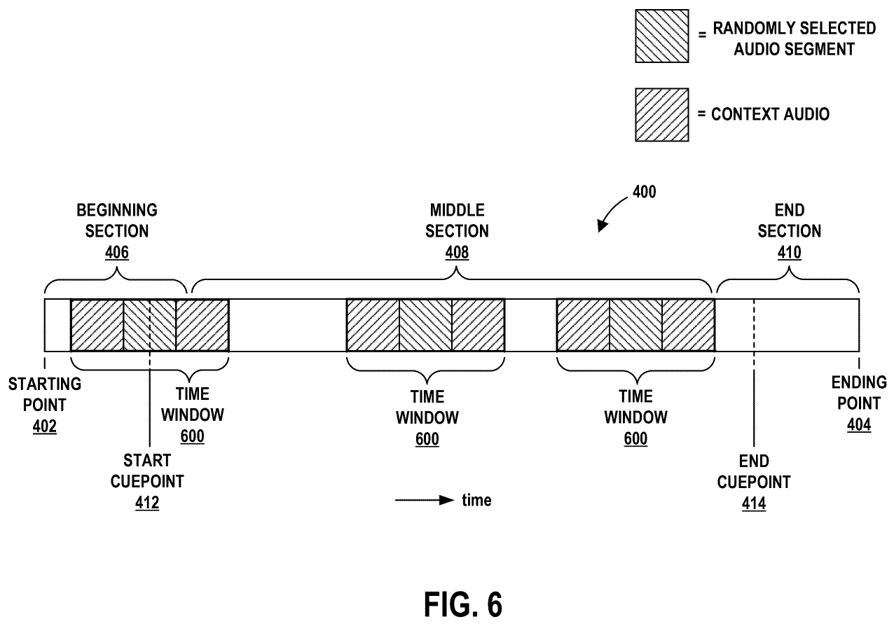

FIG. 6 illustrates examples of these training time windows that the computing system may thereby establish from example audio track 400. Namely, FIG. 6 shows three example training time windows 600, each including a randomly selected audio segment, preceding context audio, and succeeding context audio. As shown, one or more of these time windows includes a labeled start or end cuepoint in its main audio segment, and one or more other of these time windows does not include a labeled start or end cuepoint in its main audio segment (e.g., may be labeled as not including a start or end cuepoint in its main audio segment).

As to each such training time window, the computing system may obtain a frequency-component representation of the training time window. For instance, the computing system may compute a Short-Time Fourier Transform (STFT) of the training window of audio, dividing the audio of the time window into short, overlapping segments and applying a Fourier transform to each segment to establish frequency components of the audio over time (e.g., as a 2D spectrogram). Alternatively, the computing system may compute a Discrete Fourier Transform (DFT) or a Fast Fourier Transform (FFT), among other possibilities.

For each training time window, the computing system may then generate a training example. For instance, the training example could include (i) the obtained frequency-component representation of the training time window and (ii) an indication of whether or not the main audio segment of the training time window contains either a start or end cuepoint and, if so, a timestamp of that cuepoint in the training time window and possibly an indication of the nature of the cuepoint as being either a start cuepoint or an end cuepoint. Thus, having established training time windows from potentially thousands of training audio tracks, the computing system may generate potentially many thousands of these training examples.

The computing system may then provide each of these training examples as a basis to train a machine-learning model (or potentially multiple machine-learning models cooperatively) to predict the presence of cuepoints. The machine-learning model could be a neural network, and in particular a convolutional neural network (CNN), such as a Residual Network (ResNet), that includes (i) an input layer for receiving training examples as input, (ii) one or more hidden layers (e.g., convolutional layers, activation layers, and pooling layers), and (iii) an output layer. Each layer of this example CNN may comprise a number of weighted neurons, and the CNN may comprise weighted connections between layers. Further, this CNN or other machine-learning model could be run by the computing system and/or by an external computing platform.

Provided with a training example as input, the CNN may progressively process the training example through its layers and ultimately output a prediction of whether a cuepoint is present in the main audio segment of the training window represented by the training example. This prediction may be a probability estimate as to the main audio segment as a whole and/or as to small timestamped pieces of the main audio segment, such as for each 20 milliseconds of the main audio segment for instance, with a probability value from 0 to 1 indicating a predicted likelihood of presence of a cuepoint. Further, the output prediction may also indicate the nature of a predicted cuepoint, such as whether the predicted cuepoint is a start cuepoint or an end cuepoint.

A goal of training the machine-learning model with these examples may be to cause the model to learn to map the input frequency-component representation of a training time windows to an indication of whether, and if so where, the main audio segment of the training time window contains a start or end cuepoint. To do so, the model may treat the labeled indication of presence or absence of start or end cuepoints as ground truth and thus as expected output. The model may then apply a loss function (e.g., categorical cross-entropy), comparing the model's output prediction to the input cuepoint labels to calculate a loss, and the model may then update its internal weights and/or other parameters in an effort to be able to prediction of start and end cuepoints without a need for labeled input.

The computing system could train the model with many training examples until the loss function establishes a predefined threshold high level of certainty in predicting cuepoint presence. For instance, the computing system could train the model with a training target being a prediction with a predefined threshold high probability of the presence of a start or end cuepoint in a 20-millisecond portion or other bin where the training window represented by an input frequency-component representation contains a labeled start or end cuepoint.

In practice, the process of the computing system training the machine-learning model may involve the computing system applying a machine-learning trainer, such as executing program instructions that define trainer logic. Applying the machine-learning trainer may involve training a CNN. For instance, the computing system may start with a CNN that is not yet trained, initializing the CNN with randomly initiated weights and biases. The computing system could then process training data through the CNN's layers, compare the CNN's predictions to true labels, apply back-propagation to adjust weights, and apply an optimization algorithm (e.g., an Adam optimizer) to update the weights and help minimize loss, with a goal of the CNN output achieving a threshold high level of certainty.

Provided with the resulting, trained machine-learning model, the same or another computing system may then use the trained machine-learning model as a basis to predict the presence of at least one mid-track cuepoint in an audio track under test. This test audio track could be a new track that was not previously used for training the machine-learning model or could be a track that was used for training the machine-learning model based on start and/or end cuepoints. In either case, the trained machine-learning model may usefully predict presence in the test audio track of at least one mid-track cuepoint in the middle section 408 of the test audio track, even if the trained machine-learning model was trained based on just start end cuepoints in the beginning and end sections 406, 410 of training audio tracks.

In this prediction phase, the computing system may divide or chunk the test audio track into a sequence of test time windows cooperatively spanning the duration of the test audio track. Each such test time window could be configured like the training time window described above, including a main audio segment and surrounding context audio, likewise each of a short duration such as 20 seconds for instance. As an example, the initial test time window in this sequence could have a main 20 second audio segment that starts at the starting point 402 of the test audio track, with 20 seconds of preceding context audio (in this instance fully silence padded given the window position) and 20 seconds of succeeding context audio. Each next test time window in the sequence could then be shifted forward by a hop size, perhaps the same or similar to the main audio segment duration (e.g., 20 seconds), and so forth, through a final test time window whose main audio segment ends at the ending point 404 of the test audio track and has silence-padded succeeding context audio.

For each test time window, the computing system may obtain a frequency-component representation of the training time window, such as an STFT or other representation consistent with the training process.

The computing system may then provide each test time window, e.g., in sequence, as input into the trained machine-learning model, potentially without providing any information about any labeled cuepoints. Given the machine-learning model's training based on start and/or end cuepoints, the machine-learning model may process each of these input test time windows and output for each test time window a cuepoint prediction, such as a probability (e.g., 0 to 1 value) per 20-millisecond or other time segment of the main audio segment represented by the test time window of whether a cuepoint is present in the main audio segment.

The computing system may thus obtain these cuepoint predictions from the machine-learning model, based on the frequency-component representations that the computing system provided as input per test time window. The computing system may then concatenate these output cuepoint probabilities to produce an output vector for the test audio track, representing probabilities of the presence of cuepoints at each 20 millisecond interval, or with another degree of granularity, over the course of the test audio track.

The computing system may then identify the highest indicated cuepoint probability or probabilities in the test audio track and deem each identified probability respectively to indicate a predicted cuepoint in the test audio track. (E.g., a probability of over 0.4, 0.6, or 0.8 may be indicative of a cuepoint.) Further, the computing system may apply peak picking with a minimum distance, such as by not including in the set of predicted cuepoints a probability peak that is high enough to select but is threshold close to a higher probability peak.

Usefully, given the manner in which the machine-learning model was trained, at least one such predicted cuepoint may be a mid-track cuepoint that is in the middle section 408 of the test audio track. For instance, the model may predict the presence of a cuepoint in at least one test time window's main audio segment that is within the middle section 408 of the test audio track. Further, the predicted cuepoint(s) may also include one or more start and/or end cuepoint.

As noted above, the computing system or another computing system may then carry out one or more useful operations with this prediction of one or more mid-track cuepoints.

For instance, the computing system may generate metadata that indicates for the test audio track where each predicted cuepoint is in the test audio track, such as a timestamp of each mid-track cuepoint that the machine-learning model predicted with at least a threshold high level of probability to be present in the test audio track. The computing system may then provide this metadata in or with the audio track, which may facilitate operations such as allowing a DJ or other end user to jump to playout at a given mid-track cuepoint. Further, the computing system may use a pair of such cuepoints in the test audio track as a basis to identify, mark, and/or extract a portion of the audio track extending from one cuepoint to another, as an audio-track section, and the computing system may provide such an extracted portion of the audio track as a preview of the audio track, possibly by making the portion available for end users to listen to on their electronic devices 102.

In some implementations, as indicated above, the computing system may use the present cuepoint predictions as a basis to help with music structural segmentation and beat detection. In particular, certain cuepoints predicted through the present process may fall on the downbeat (i.e., the first beat of a measure), which may often coincide with the start of a music structural segment (e.g., a verse or chorus). Given this, resulting applications could include music rearrangement (e.g., remixing a track by rearranging its sections in a different order, preferably in a beat-aligned way so that rhythm is preserved), navigation aids for music exploration (e.g., allowing a user to quickly explore a musical track based on visual highlights of the different sections, possibly with a skip/jump button that allows the user to skip to a next or previous section), among other possibilities.

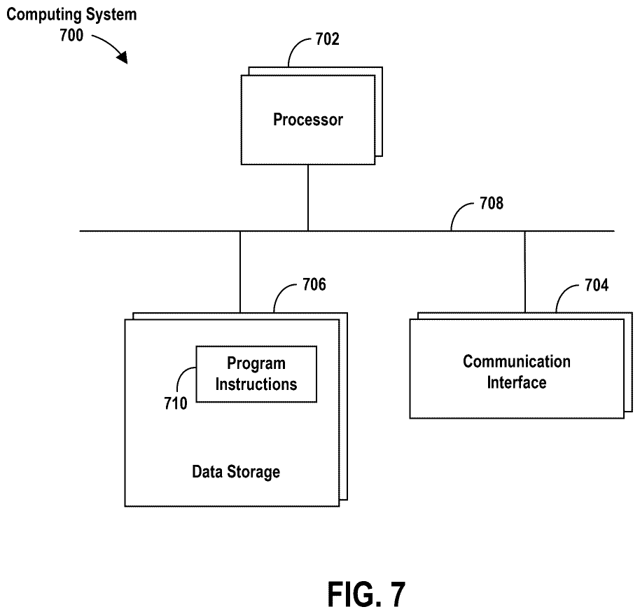

FIG. 7 is a simplified block diagram of a computing system 700 that could be configured to carry out various operations such as those described herein. This computing system may be at or part of the media content server 104 and/or may be provided separately. Further, this computing system may effectively comprise multiple computing systems configured respectively to carry out separate respective operations as described here, such as one computing system that carries out training of the machine-learning model based on start and/or end cuepoints, one computing system that carries out using the trained machine-learning model to predict one or more mid-track cuepoints, and one computing system that makes use of the prediction.

As shown in FIG. 7, the example computing system includes at least one processor 702, at least one communication interface 704, and non-transitory data storage 706, any or all of which may be integrated together to various extents and/or communicatively linked with each other by a system bus, network, or other connection mechanism 708.

The at least one processor 702 may include one or more general purpose processors (e.g., microprocessors) and/or one or more specialized processors (e.g., DSPs, GPUs, NPUs, etc.) The at least one communication interface 704 may comprise a network communication interface, perhaps a wired and/or wireless Ethernet communication module, among other possibilities, to facilitate communicating with other entities. And the non-transitory data storage 706 may include one or more volatile and/or non-volatile storage components (e.g., flash, optical, magnetic, ROM, RAM) (e.g., DRAM, SRAM, or DDRAM), EPROM, and/or EEPROM, etc.), which may be integrated in whole or in part with the processor 702 or may be provided separately. As further shown, the data storage 706 may store program instructions 710, which may be executable by the processor 702 to carry out various computing system operations.

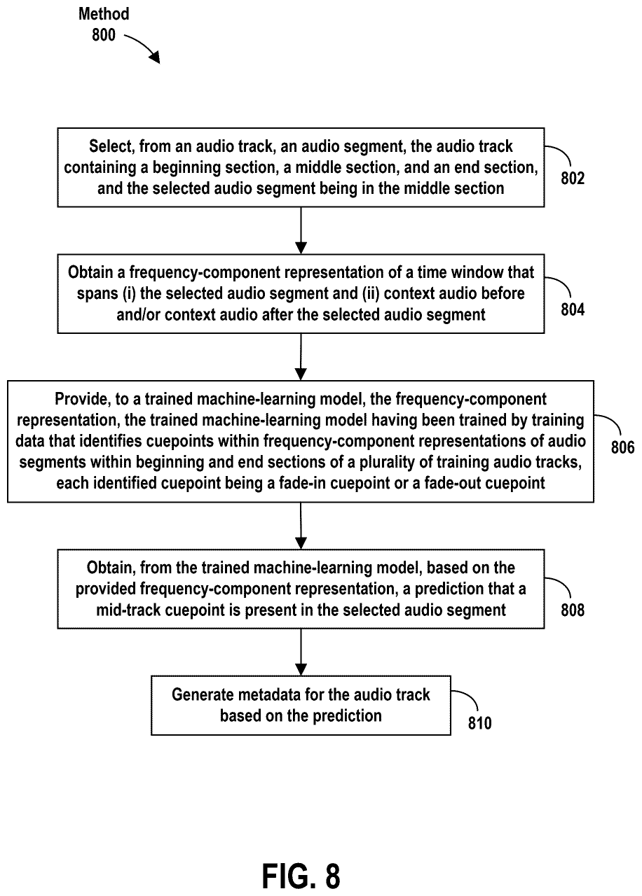

FIG. 8 is a flow chart illustrating an example computer-implemented method 800 that may be carried out by the example computing system 700, among other possibilities.

As shown in FIG. 8, at block 802, the example method 800 includes selecting, from an audio track, an audio segment, the audio track containing a beginning section, a middle section, and an end section, and the selected audio segment being in the middle section. Further, at block 804, the example method includes obtaining a frequency-component representation of a time window that spans (i) the selected audio segment and (ii) context audio before the audio segment and/or context audio after the selected audio segment, i.e., at least one of context audio before the selected audio segment or context audio after the selected audio segment. Still further, at block 806, the example method includes providing, to a trained machine-learning model, the frequency-component representation, the trained machine-learning model having been trained by training data that identifies cuepoints within frequency-component representations of audio segments within beginning and end sections of a plurality of training audio tracks, each identified cuepoint being a fade-in cuepoint or a fade-out cuepoint. At block 808, the example method includes obtaining, from the trained machine-learning model, based on the provided frequency-component representation, a prediction that a mid-track cuepoint is present in the selected audio segment. And at block 810, the example method includes generating metadata for the audio track based on the prediction.

In line with the discussion above for example, the training data in this method may identify only fade-in and/or fade-out cuepoints and may thus be devoid of any identification of mid-track cuepoints.

Further, as discussed above for example, the training data may include, for each of the plurality of training audio tracks, a plurality of training data sets each including (a) a frequency-component representation of a respective training time window of the training audio track, the respective training time window spanning (i) a respective training audio segment randomly selected from the training audio track and (ii) respective context audio before and after the respective training audio segment, and (b) an indication of whether and if so where in the respective training audio segment of the training audio track there is a fade-in or fade-out cuepoint.

Still further, as discussed above for example, the respective context audio might not include any indicated cuepoints, i.e., might be devoid of any indicated cuepoints. In addition, a given training time window may extend beyond a beginning or end of the training audio track, and the context audio in the given training time window may be silence padded. Further, in each respective training time window, the respective training audio segment and the context audio before and after the respective training audio segment may each have a duration in a range of 10 to 30 seconds, such as 20 seconds for instance.

As additionally discussed above for example, the method may also include providing the generated metadata to facilitate jumping to the predicted mid-track cuepoint in the audio track, e.g., to facilitate browsing to, navigating to, and/or playing out audio starting from the time position of the predicted mid-track cuepoint.

Further, as discussed above for example, if the audio segment is considered a first audio segment, the prediction is considered a first prediction, and the mid-track cuepoint is considered a first mid-track cuepoint, the method may also include repeating the operations of FIG. 8 for a second audio segment in the middle section of the audio track, including (i) obtaining from the trained machine-learning model a second prediction that a second mid-track cuepoint is present in the second audio segment, and (ii) extracting, based on the first prediction and the second prediction, a mid-track section of the audio track extending from the first mid-track cuepoint to the second mid-track cuepoint. Yet further, the method could include providing the extracted mid-track section as a preview of the audio track. (Note that the terms “first” and “second” as used here are merely distinct labels and do not necessarily denote timing.)

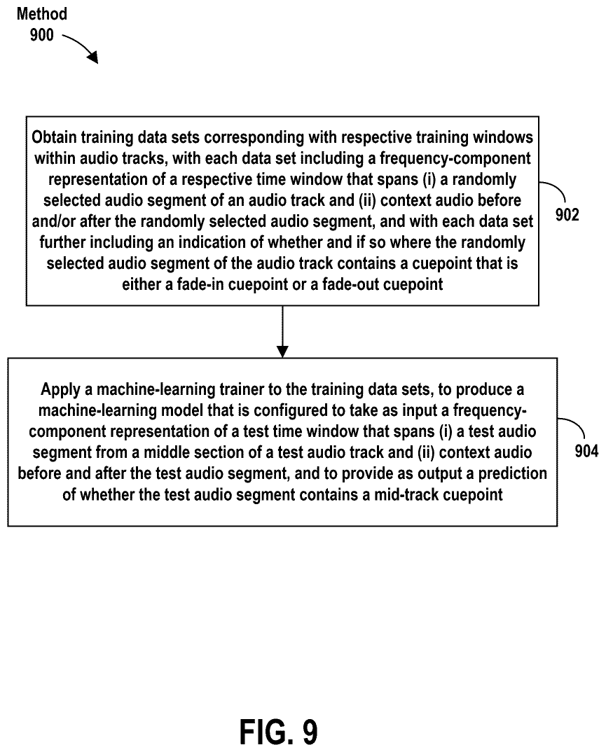

FIG. 9 is a flow chart illustrating another example computer-implemented method 900 that may be carried out by the example computing system 700, among other possibilities, perhaps along with method 800.

As shown in FIG. 9, at block 902, the example method 900 includes obtaining training data sets corresponding with respective training windows within audio tracks, with each data set including a frequency-component representation of a respective time window that spans (i) a randomly selected audio segment of an audio track and (ii) context audio before and/or after the randomly selected audio segment, and with each data set further including an indication of whether and if so where the randomly selected audio segment of the audio track contains a cuepoint that is either a fade-in cuepoint or a fade-out cuepoint. Further, at block 904, the method includes applying a machine-learning trainer to the training data sets, to produce a machine-learning model that is configured to take as input a frequency-component representation of a test time window that spans (i) a test audio segment from a middle section of a test audio track and (ii) context audio before and/or after the test audio segment, and to provide as output a prediction of whether the test audio segment contains a mid-track cuepoint.

While the above description has discussed identifying mid-track cuepoints, note that various disclosed principles could be applied as well to facilitate identifying cuepoints anywhere in an audio track, not limited to mid-track. For instance, using a limited number of cuepoint labels not limited to start and end cuepoints specifically, a computing system could use the disclosed consideration of context audio as a basis to train a machine-learning model and/or may apply such a trained model to detect cuepoints anywhere in the audio track. Training the model based on training examples that encompass various randomly selected audio segments along with preceding and/or succeeding context audio may usefully teach the model to detect the presence of cuepoints anywhere throughout an audio track at issue.

In addition, the present disclosure also contemplates non-transitory data storage (e.g., one or more non-transitory computer-readable medium components (e.g., flash, optical, magnetic, ROM, RAM) (e.g., DRAM, SRAM, or DDRAM), EPROM, and/or EEPROM, and/or other computer-readable media, etc.)) holding program instructions executable by at least one processor of a device to cause a computing system to carry out various operations described herein.

Further, the present disclosure also contemplates a computer program comprising a set of program instructions executable by at least one processor of a computing system to carry out (e.g., to cause the computing system to carry out) various operations described herein. In an example implementation, the computer program could further be stored in non-transitory data storage such as that noted above, among other possibilities.

### Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any flow charts, for instance, a step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the claims.

What is claimed is:

1. A computer-implemented method comprising:
selecting, from an audio track, an audio segment, wherein the audio track contains a beginning section, a middle section, and an end section, and wherein the selected audio segment is in the middle section;
obtaining a frequency-component representation of a time window spanning (i) the selected audio segment and (ii) at least one of context audio before the selected audio segment or context audio after the selected audio segment;
providing, to a trained machine-learning model, the frequency-component representation, wherein the trained machine-learning model has been trained by training data that identifies cuepoints within frequency-component representations of audio segments within beginning and end sections of a plurality of training audio tracks, wherein each identified cuepoint is a fade-in cuepoint or a fade-out cuepoint;
obtaining, from the trained machine-learning model, based on the provided frequency-component representation, a prediction that a mid-track cuepoint is present in the selected audio segment within the middle section of the audio track; and
generating metadata for the audio track based on the prediction.

2. The computer-implemented method of claim 1, wherein the training data is devoid of any identification of mid-track cuepoints.

3. The computer-implemented method of claim 1, wherein the training data includes, for each of the plurality of training audio tracks, a plurality of training data sets each comprising:
a frequency-component representation of a respective training time window of the training audio track, wherein the respective training time window spans (i) a respective training audio segment randomly selected from the training audio track and (ii) respective context audio before and after the respective training audio segment; and
an indication of whether and if so where in the respective training audio segment of the training audio track there is a fade-in or fade-out cuepoint.

4. The computer-implemented method of claim 3, wherein the respective context audio is devoid of any indicated cuepoints.

5. The computer-implemented method of claim 3, wherein a given training time window extends beyond a beginning or end of the training audio track, and wherein the context audio in the given training time window is silence padded.

6. The computer-implemented method of claim 3, wherein in each respective training time window, the respective training audio segment and the context audio before and after the respective training audio segment each have a duration in a range of 10 to 30 seconds.

7. The computer-implemented method of claim 6, wherein the duration is 20 seconds.

8. The computer-implemented method of claim 1, further comprising providing the generated metadata to facilitate playing out audio from the predicted mid-track cuepoint in the audio track.

9. The computer-implemented method of claim 1, wherein the audio segment is a first audio segment, the prediction is a first prediction, and the mid-track cuepoint is a first mid-track cuepoint, the method further comprising:
repeating the method for a second audio segment in the middle section of the audio track, including obtaining from the trained machine-learning model a second prediction that a second mid-track cuepoint is present in the second audio segment; and
extracting, based on the first prediction and the second prediction, a mid-track section of the audio track extending from the first mid-track cuepoint to the second mid-track cuepoint.

10. The computer-implemented method of claim 9, further comprising:
providing the extracted mid-track section of the audio track as a preview of the audio track.

11. A computing system comprising:
at least one processor;
non-transitory data storage; and
program instructions stored in the non-transitory data storage and executable by the at least one processor to cause the computing system to carry out operations comprising:
selecting, from an audio track, an audio segment, wherein the audio track contains a beginning section, a middle section, and an end section, and wherein the selected audio segment is in the middle section,
obtaining a frequency-component representation of a time window spanning (i) the selected audio segment and (ii) at least one of context audio before the selected audio segment or context audio after the selected audio segment,
providing, to a trained machine-learning model, the frequency-component representation, wherein the trained machine-learning model has been trained by training data that identifies cuepoints within frequency-component representations of audio segments within beginning and end sections of a plurality of training audio tracks, wherein each identified cuepoint is a fade-in cuepoint or a fade-out cuepoint,
obtaining, from the trained machine-learning model, based on the provided frequency-component representation, a prediction that a mid-track cuepoint is present in the selected audio segment within the middle section of the audio track, and
generating metadata for the audio track based on the prediction.

12. The computing system of claim 11, wherein the training data is devoid of any identification of mid-track cuepoints.

13. The computing system of claim 11, wherein the training data includes, for each of the plurality of training audio tracks, a plurality of training data sets each comprising:
a frequency-component representation of a respective training time window of the training audio track, wherein the respective training time window spans (i) a respective training audio segment randomly selected from the training audio track and (ii) respective context audio before and after the respective training audio segment; and
an indication of whether and if so where in the respective training audio segment of the training audio track there is a fade-in or fade-out cuepoint.

14. The computing system of claim 13, wherein the respective context audio is devoid of any indicated cuepoints.

15. The computing system of claim 13, wherein a given training time window extends beyond a beginning or end of the training audio track, and wherein the context audio in the given training time window is silence padded.

16. The computing system of claim 13, wherein in each respective training time window, the respective training audio segment and the context audio before and after the respective training audio segment each have a duration in a range of 10 to 30 seconds.

17. The computing system of claim 11, wherein the operations further include providing the generated metadata to facilitate jumping to the predicted mid-track cuepoint in the audio track.

18. The computing system of claim 11, wherein the audio segment is a first audio segment, the prediction is a first prediction, and the mid-track cuepoint is a first mid-track cuepoint, the operations further comprising:
repeating the operations for a second audio segment in the middle section of the audio track, including obtaining from the trained machine-learning model a second prediction that a second mid-track cuepoint is present in the second audio segment;
extracting, based on the first prediction and the second prediction, a mid-track section of the audio track extending from the first mid-track cuepoint to the second mid-track cuepoint; and
providing the extracted mid-track section of the audio track as a preview of the audio track.

19. Non-transitory data storage having stored program instructions executable by at least one processor of a computing system to cause the computing system to carry out operations comprising:
selecting, from an audio track, an audio segment, wherein the audio track contains a beginning section, a middle section, and an end section, and wherein the selected audio segment is in the middle section;
obtaining a frequency-component representation of a time window spanning (i) the selected audio segment and (ii) at least one of context audio before the selected audio segment or context audio after the selected audio segment;
providing, to a trained machine-learning model, the frequency-component representation, wherein the trained machine-learning model has been trained by training data that identifies cuepoints within frequency-component representations of audio segments within beginning and end sections of a plurality of training audio tracks, wherein each identified cuepoint is a fade-in cuepoint or a fade-out cuepoint;
obtaining, from the trained machine-learning model, based on the provided frequency-component representation, a prediction that a mid-track cuepoint is present in the selected audio segment within the middle section of the audio track; and
generating metadata for the audio track based on the prediction.

20. The non-transitory data storage of claim 19,
wherein the training data is devoid of any identification of mid-track cuepoints,
wherein the training data includes, for each of the plurality of training audio tracks, a plurality of training data sets each comprising (a) a frequency-component representation of a respective training time window of the training audio track, wherein the respective training time window spans (i) a respective training audio segment randomly selected from the training audio track and (ii) respective context audio before and after the respective training audio segment and (b) an indication of whether and if so where in the respective audio segment of the training audio track there is a fade-in or fade-out cuepoint, and
wherein the respective context audio is devoid of any indicated cuepoints.
